(19) United States
(12) Patent Application Publication
(10) Pub. No.: US 2002/0032975 A1
(43) Pub. Date: Mar. 21, 2002

(54) Mobile advertising system

(76) Inventor: Gwon Sik Shin, Choongjoo (KR)

Correspondence Address: Guon Sik Shin, Yonsoo Joogong 4-danji Apt 404-1104, yonsoo-dong 686, Choongjoo-shi, Choongchungbuk-do, KR

(21) Appl. No.: 09/960,045

(22) Filed: Sep. 20, 2001

(30) Foreign Application Priority Data
Sep. 20, 2000 (KR) 20-0221432

(51) Int. Cl. G09F 1/00

(52) U.S. Cl. 40/466

(57) ABSTRACT

This invention is called a Mobile Advertising System. It is designed to move the billboards and shelves on which goods are advertised. The present invention is compromised of: a rail of a specific length; a moving element which moves the billboard and the shelf on which goods are advertised; a sensor which detects the movement of the people walking by; and a control unit which controls the servo motor of the said moving element so that the billboard or the shelf may move according to the output signal of the said sensor in the same direction and at the same speed of the pedestrians.

This invention moves the billboard and shelf on which goods are displayed in the same direction and at the same speed of the people walking by, so that they can fully see the advertisement on the billboard and goods displayed on the shelf while they walk. Unlike other fixed billboards and display shelves currently available on the market, the present invention is provided with a differentiated mobile system to maximize the advertising effect by drawing the attention of the passers-by.

### RELATED APPLICATION

This application claims the benefit of patent application number 20-0221432, filed Sep. 20, 2000, in the Korea Intellectual Property Office (“KIPO”) for an invention having the above-stated title. As-filed KIPO patent application number 20-0221432 (“Foreign Application”) is hereby incorporated herein by reference. The English language translation of the Foreign Application is the remainder of this document, and the Translator's Declaration applies to the remainder of this document.

### BACKGROUND OF THE INVENTION

1. Field of Invention and Prior Art

This invention relates to a mobile advertising system which is designed to move the billboard and the shelf on which goods are displayed so that passers-by can thoroughly see the advertisement on the billboard and the goods displayed on the shelf while they walk as the billboard and displayed goods move in the same direction and at the same speed of the walkers.

The core objective of this advertisement is to promote the sales of the products and to stimulate demand from the customers by putting advertisements in newspapers, on TV, on the radios, in magazines and in other sources of advertisement or by displaying goods on store shelves and other places.

Advertisement in the newspaper, on TV, on the radio and in magazines brings a satisfactory result to the advertiser, but the cost is very high. And for this reason, advertisement through billboards and show-windows are most commonly used because they are the most economical means of advertising. When goods are displayed in show-windows or advertisements are put on fixed billboards, passers-by cannot see them fully as they walk and the results from these advertising means are not satisfactory, although these advertisement methods may be effective for those who stop to look at these advertisements.

### SUMMARY OF THE INVENTION

To solve the said problems of the current advertising systems and methods, the present invention is a mobile advertising system which moves the billboard and the shelf on which goods are displayed so that passers-by can thoroughly see the advertisement on the billboard and the goods displayed on the shelf as they walk past since the billboard and displayed goods move in the same direction and at the same speed of the walkers.

The present invention is compromised of a rail of a specific length; a moving element which moves the billboard and the shelf on which goods are displayed; a sensor which detects the movement of the people walking by and a control unit which controls the servo motor of the said moving element so that the billboard or the shelf may move according to the output signal of the said sensor in the same direction and at the same speed of the walkers.

The said sensor is comprised of several infrared ray sensors evenly arranged on the sensor bars that are installed in parallel to the said rail.

The said mobile advertising system is compromised of a control unit that controls the reception of the output signals of the infrared rays sensors, which detect the passers-by, and are arranged inside the sensor bars. They take in the surrounding output signals of the infrared rays sensors as proper input signals but ignore other signals outputted by other infrared rays sensors.

The said moving element is compromised of traveling wheels that make contact with the top of the said rail; a rotary shaft connected to the said traveling wheels; decelerating motor gears which transfer the rotation power to the said servo motor; and, rollers that are tightly fastened to the bottom of the rail, to prevent the moving element from shaking.

The said mobile advertising system further includes: limit switches 1 and 2, installed at the end of the right side and left side of the said rail to detect whether or not the said moving element is off the range of the movement of the rail.

### BRIEF DESCRIPTION OF THE DRAWINGS

FIG. 1 is an overview of the mechanism of the present invention.

FIG. 2 is a section drawing which shows the moving element as depicted in FIG. 1.

FIG. 3 is a block drawing which shows the control unit that activates the moving element depicted in FIG. 1.

FIG. 4 is a circuit diagram of the signal processing part depicted in FIG. 3.

FIG. 5 is an illustrative drawing which shows the servo motor control unit depicted in FIG. 3.

FIG. 6 is an overview of the invention in another application.

### DESCRIPTION OF THE PREFERRED EMBODIMENT

The functions and structure of the present invention as depicted in the drawings are as follows:

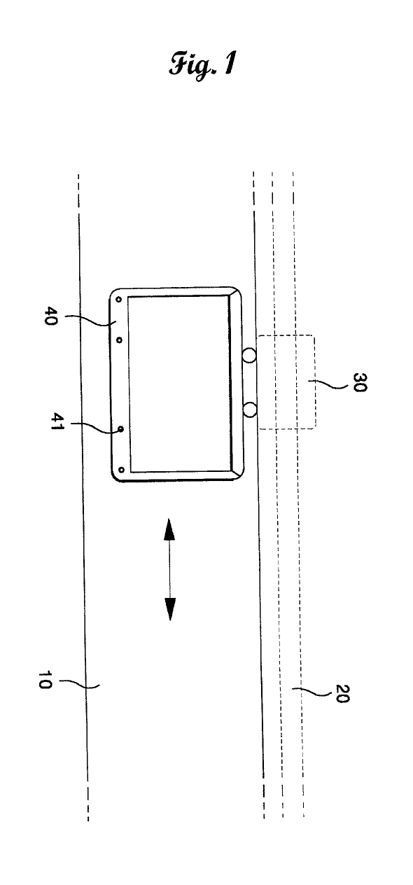

FIG. 1 is an overview of the mechanism of the invention. The rail (20) is fixed on the top of the inside space which is composed of a transparent window (10), a moving element (30) is installed on the said rail (20) to move a billboard (40) or a shelf on which goods are displayed, and several infrared ray sensors (41) are installed on the designated areas of the said billboard (40).

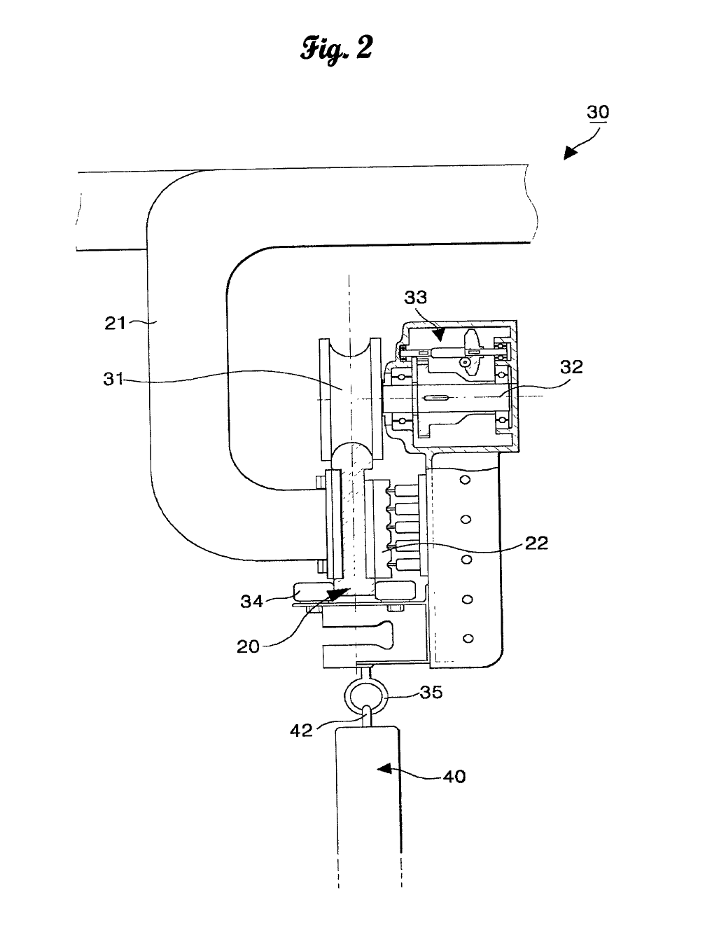

As shown in FIG. 2, the said rail (20) which supports the said billboard (40) or a shelf, is fixed to the top of the inside space of the said transparent window (10), through the fixed bracket (21) and the traveling wheels (31) of the moving element are placed on the top of the said rail (20). A rotary shaft (32) is connected to the said traveling wheels (31) and the said rotary shaft (32) is connected to the servo motor (not depicted in the drawing), through the decelerating motor gear (33).

A roller (34) is in close contact with the bottom of the said rail (20) to prevent the moving element (30) from shaking and a power supply element (22), which supplies power to the servomotor, is provided on one side of the said rail (20). A connection ring (35) is provided on the bottom of the said moving element (30) and a connection hook (42) that connects the said connection ring (35) is provided on the top of the billboard (40) or on the top of the shelf where goods are displayed.

Although the said moving element (30) which moves the said billboard (40) or the shelf on which goods are displayed is installed on the said rail (20) which is fixed on the top of the inside space of the transparent window (10) in this figure, the said rail (20) may be also installed on the ground. Anyone who has common knowledge on the relevant technology may easily embody this mechanism according to this example.

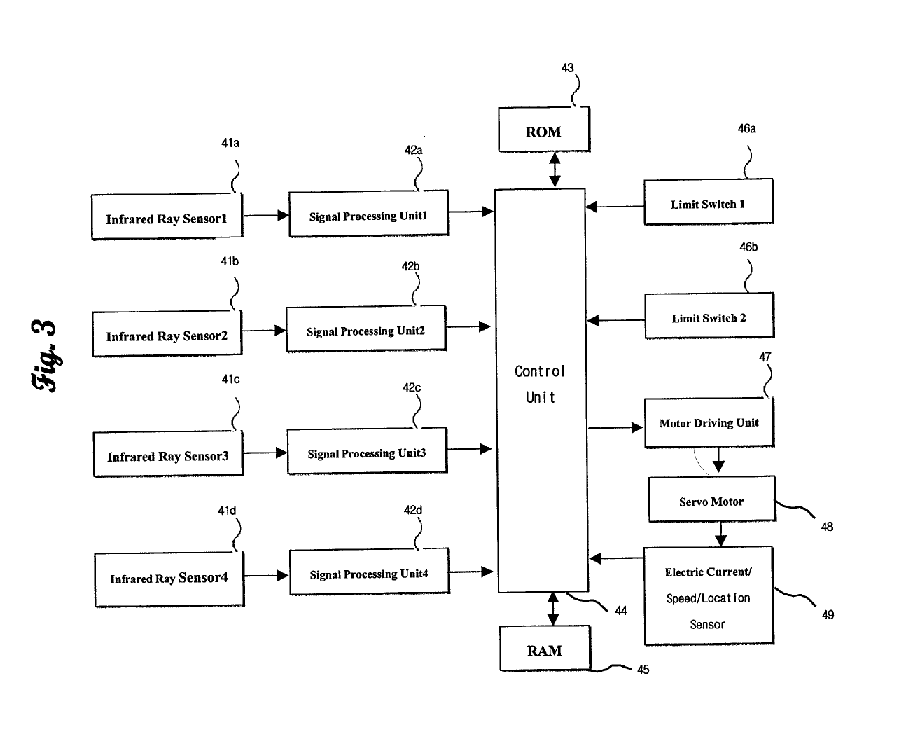

FIG. 3 is a block drawing which shows the circuits of the control unit that moves the said billboard (40) and the said shelf by inversely rotating the servo motor and detecting the passers-by according to the direction they are walking. A series of infrared rays sensors (41a˜41d) which detect the passers-by are provided on the front area of the said billboard (40). The said infrared ray sensors (41a˜41d) are pyroelectric IR sensors.

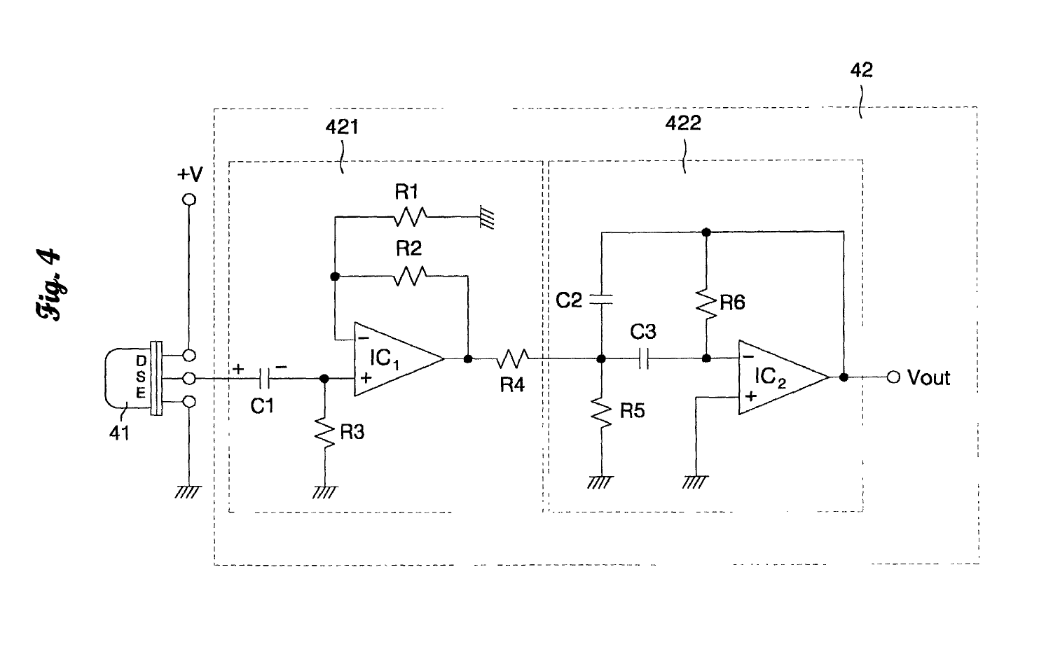

Signal processing units (42a˜42d) which maintain the output signals within their proper ranges are connected to the output terminal of the said infrared ray sensors (41a˜41d). As shown in FIG. 4, the said signal processing units (42a˜42d) comprise of the amplifying circuit unit (421) which amplifies the output signals of the infrared rays sensors (41) and the band pass filter (422) which filters the output signals of the said amplifying circuit unit (421).

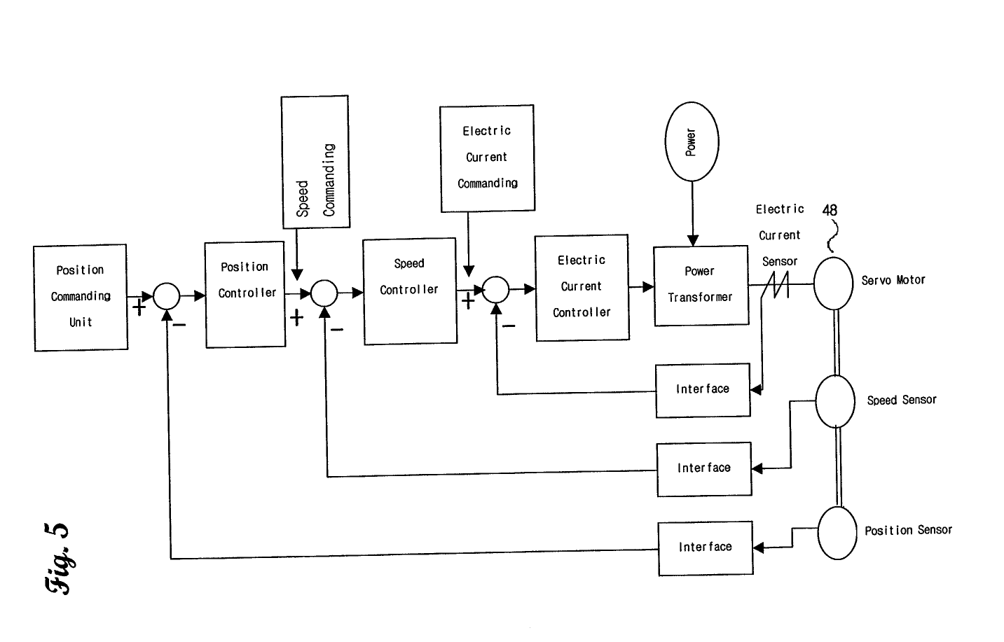

The control unit (44) detects the direction and walking speed of the passers-by according to the output signals of the signal processing units (42a˜42d) and controls the direction and speed of revolution of the said servo motor (48) through the motor driving unit (47) according to the result. As shown in FIG. 5, the said control unit (44) detects the capacity, speed of revolution and location impressed on the said servo motor (48) through the current/speed/location sensor (49) according to the general motor controlling method. Then, it compares these to the walking speed of the passers-by and controls the direction and speed of the revolution of the said servo motor (48) to correspond to the direction and speed of the passers-by.

Limit switches 1 and 2 (46a˜46b) which limit the movement of the moving element (30) so that the said moving element (30) may not be off the range of movement of the said rail (20) are connected to the control unit (44). Therefore, if either one of the said limit switches, (46a˜46b) installed on the both ends of the said rail (20), is on, the said control unit (44) stops the said servo motor (48) to prevent the moving element from going out of the range of the movement or colliding with the wall or other surrounding objects.

Part number 43 in FIG. 3, which is not described, is the ROM which contains the program necessary to activate the present invention and part number 45 in the same FIG. 3 is the RAM in which the program and data necessary for the activation of the present invention are temporarily stored.

The following is a description of how to operate the present invention which is composed as mentioned above:

If a passer-by moves from the left side of the billboard (40) to the right, the infrared ray sensor 1 (41a) first detects the passer-by and the output of the infrared ray sensors (41a˜41d) becomes 1000, whereas the output of the said infrared ray sensors (41a˜41d) becomes 0100 as infrared ray sensor 2 (41b) detects the passer-by.

When the output signal of the infrared ray sensors (41a˜41d) becomes 0100, the said control unit (44) activates the said servo motor (48) through the motor driving unit (47). The control unit (44) controls the driving of the said servo motor (48) so the said billboard (40) may move from the left to the right at the average walking speed of normal people, which is 4 Km/h.

When the walking speed of the passers-by is faster than the traveling speed of the said billboard (40), the said infrared rays sensors (41a˜41d) output the 0010 signal or 0001 signal. When the output signals from the said infrared ray sensors (41a˜41d) are transmitted to the said control unit (44), the said control unit (44) activates the said servo motor (48) faster than the normal speed to move the said billboard (40) from the left to the right. In other words, the said control unit (44) compares the output signals of the said infrared ray sensors (41a˜41d) and the revolution speed of the said servo motor (48) to move the said billboard (40) with the same speed as that of the passers-by.

Contrary to this, when the walking speed of the passers-by is slower than that of the billboard (40), the said infrared ray sensors (41a˜41d) output a 1000 signal. When the output signals from the said infrared ray sensors (41a˜41d) are transmitted to the said control unit (44), the said control unit (44) activates the said servo motor (48) slower than the normal speed, to move the said billboard (40) from the left to the right with the same walking speed of the passers-by.

As such, the said billboard (40) travels, and when the said moving element (30) turns on the limit switch 2 (46b) which is installed on the left end of the said rail (20), the said control unit (44) gradually decreases the electric current sent to the said servo motor (48), to stop the movement of the said moving element (30).

When the passers-by pass the said billboard (40) from the left to the right, the infrared ray sensor (41d) first detects the passer-by. Accordingly, the output of the said infrared ray sensors (41a˜41d) becomes 0001 whereas it becomes 0010 as the infrared rays sensor (41c) detects the passers-by.

When the output signal from the said infrared ray sensors (41a˜41d) becomes 0010, the said control unit (44) activates the said servo motor (48) through the said motor driving unit (47). The said control unit (44) controls the activation of the said servo motor (48) to move the said billboard (40) from the right to the left with the same speed as the walking speed (4 Km/h) of the passers-by.

When the walking speed of the passers-by is faster than the traveling speed of the said billboard (40), the said infrared ray sensors (41a˜41d) output a 0100 signal or a 1000 signal. The said control unit (44) activates the said servo motor (48) faster than the normal speed when the output signals from the said infrared ray sensors (41a˜41d) are transmitted to the said control unit (44) to move the said billboard (44) from the right to the left with the same speed as the walking speed of the passers-by.

When the walking speed of the passers-by is slower than the traveling speed of the said billboard (40), the said infrared rays sensors (41a˜41d) output a 0001 signal. The said control unit (44) activates the said servo motor (48) slower than the normal speed when the output signals from the said infrared rays sensors (41a˜41d) are transmitted to the said control unit (44) to move the said billboard (44) from the left to the right with the same speed as the passers-by.

When the said billboard (40) travels and the said moving element (30) turns on the limit switch 1 (46a) installed on the right-end of the said rail (20), the said control unit (44) gradually decreases the electric current sent to the said servo motor (48) to stop the said moving element (30).

When the said infrared ray sensors (41a˜41d) detect passers-by, the said servo motor (48) of the said moving element (30) is activated to move the said billboard (40). With the use of the audio system to publicize the advertisement put on the said billboard (40), the effect of the advertisement may be enhanced.

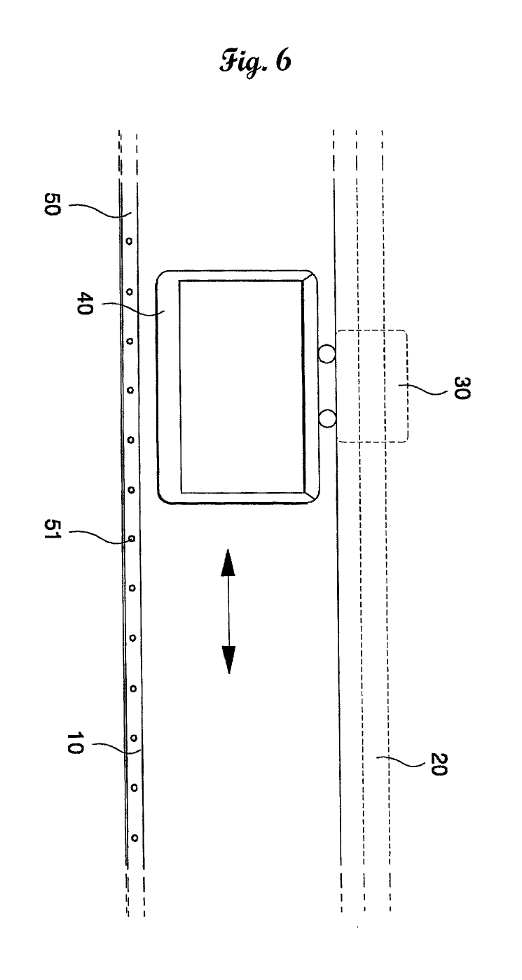

FIG. 6 is an illustrative drawing, which depicts the overview of the present invention in a different structure. The structure of the system of the present invention in this figure is the same as that described above, except the infrared ray sensors (51), which detect passers-by, are installed on the sensor bar (50) at a proper distance and the said sensor bar (50) is installed in parallel to the rail (20).

In this structure of the present invention, one of the said infrared ray sensors (51) installed on the said sensor bar (50) detects passers-by passing within the detection range of the said infrared ray sensors (51). When passers-by are detected, the said control unit (44) activates the said servo motor (48) and moves the moving element, that is the said billboard (40), to the location where the said infrared ray sensors (51) detected a passer-by.

The said control unit (44) activates the said servo motor (48) according to the traveling of passers-by and moves the said billboard (40) to the location where the said infrared rays sensors (51) detected a passer-by. The said control unit (44) receives the output signals of the said infrared ray sensors (51) which detected passers-by, and the output signals of the surrounding of the said infrared rays sensors (51), but ignores other signals outputted from some of the said infrared rays sensors (51). This is to prevent mis-operation of the present invention that may occur when more than two passers-by come within the detection range of the said infrared ray sensors (51).

When passers-by are out of the detection range of the said infrared rays sensors (51), the said control unit (44) initializes the system, including the said infrared ray sensors (51) installed on the said sensor bar (50), and detects other passers-by within the detecting range through the said infrared ray sensors (51) installed on the said sensor bar (50).

### BENEFITS OF THE INVENTION

As such, the present invention moves a billboard or a shelf on which goods are displayed in the same direction and at the same speed of the walkers so that they may thoroughly see the advertisement while they walk, drawing their attention to the advertisement and maximizing the results of the advertisement.

Although the mechanism and structure of the present invention are described according to the provided drawings, they are just general illustrations of the present invention, and it is expected that anyone who has common knowledge about the mechanism and technology of the present invention will understand that a variety of different applications are available from the said applications described above. Therefore, the scope of the technical protection of the present invention shall be decided within the scope of the claims of the attached registration of the utility design.

I claim:

1. A mobile advertising system, which moves a billboard or a shelf on which goods are displayed, is compromised of:
a rail (20) with a specified length; a moving element (30) which travels on the said rail (20) to move a billboard (40) or a goods-displaying shelf; infrared ray sensors (41 and 51) which detect passers-by and their movement; a control unit (44) which controls the servo motor (48) on the said moving element (30) to move a billboard (40) or a shelf to the same direction and speed of passers-by, according to the output signals of the said infrared rays sensors (41 and 51).

2. A mobile advertising system as in claim 1, wherein the said infrared ray sensors (41 and 51) comprise more than two infrared rays sensors installed on the specific area of the said billboard (40) or a shelf.

3. A mobile advertising system as in claim 2, wherein the said infrared ray sensors (41 and 51) are compromised of several infrared ray sensors installed within the sensor bar in parallel with the said rail (20) with specific intervals.

4. A mobile advertising system as in claim 3, wherein the said mobile advertising system is compromised of a control unit (44) which receives the output signals of the said infrared rays sensors (41 and 51) which detects passers-by and the output signals of the surrounding said infrared rays sensors (41 and 51), but ignores other signals outputted from some of the said infrared ray sensors (41 and 51).

5. A mobile advertising system as in claim 1, 2, 3, or 4, wherein the said moving element (30) is compromised of a traveling wheel (31) installed on the top of the said rail (20); a rotary shaft (32) connected to the said traveling wheel (31); a decelerating motor gear (33) which transmits the revolution of the servo motor (48) to the said rotary shaft (32); and a roller (34) which is in close contact with the bottom of the said rail (20) to prevent the said moving element (30) from shaking.

6. A mobile advertising system as in claim 1, 2, 3, or 4, wherein the said mobile advertising system is compromised of limit switches 1 and 2 that are installed on both the right end and left end of the said rail (20) to detect whether or not the said moving element (30) goes out of the traveling range of the said rail (20).
